(19) United States
(12) Patent Application Publication
(10) Pub. No.: US 2008/0198616 A1
(43) Pub. Date: Aug. 21, 2008

(54) LIGHT EMITTING DIODE FOR AUTOMOTIVE LAMP

(76) Inventor: Han-Chung LAI, JhongLi City (TW)

Correspondence Address: RABIN & Berdo, PC, 1101 14TH STREET, NW, SUITE 500, WASHINGTON, DC, 20005, US

(21) Appl. No.: 12/032,134

(22) Filed: Feb. 15, 2008

(30) Foreign Application Priority Data
Feb. 15, 2007 (TW) 096202973

(51) Int. Cl. B60Q 1/26

(52) U.S. Cl. 362/540

(57) ABSTRACT

A light emitting diode (LED) for automotive lamp is described. The LED has a cross-axis symmetrical optical structure on a light emitting path. When the LED emits light, a light form of the light assumes a symmetrical cross-axis distribution due to the optical structure.

### FIELD OF THE INVENTION

The present invention relates to a light emitting diode (LED), more particularly, to a structural improvement of an LED for an automotive lamp.

### BACKGROUND OF THE INVENTION

Traditionally, lamps for automobiles use bulbs as light sources, and have a painted cover added additionally according to different uses of the automotive lamps. However, such application wastes energy, and due to the short working life of the bulbs, if the bulbs are damaged suddenly during running, human life will be threatened. In order to eliminate such situation, alternative light sources for replacing the bulbs are available on the market.

Currently, the most commonly used alternative light sources are light emitting diodes (LEDs). LED is a light emitting component of semiconductor process and has the advantages of good vibration resistance, being power saving, long working life, without idling time, rapid response speed, having diverse and pure colors, and thus the disadvantages of conventional bulbs, such as power wasting and short working life, can be effectively alleviated. Further, if the LED has a circuit design control, it can exert the functions after being damaged, thus avoiding the traffic accidents due to disabled light source.

Further, Economic Commission for Europe (ECE) and Society of Automotive Engineers (SAE) have defined test regulations on the luminous intensity and light form of automotive lamps. The light forms of the regulation assume a symmetrical cross-axis light form distribution. In order to meet the requirements of the regulation, various improvements for automotive lamps have been developed on the market, such as ROC Patent No. 258550, titled miniaturized LED lighting module for LED head light module, in which a light guide component is disposed on a light exit surface of an LED, the light beam of the LED is gathered and then emitted from a light emitting side. The light emitting side of the light guide component has a shield for regulating the light form according to the automotive lamp regulations, such that the light beam emitted from the light emitting side is partially shielded, thus achieving the purpose of modifying the light form of the emitted light beam to meet the light form regulated by the automotive lamp regulations. However, although the patent can meet the requirements of the regulations, for baffling a part of the light source, a shield is required to be additionally disposed and the light energy is wasted, and thus the cost and the power consumption are increased.

### SUMMARY OF THE INVENTION

Accordingly, the present invention is directed to an LED for an automotive lamp, such that when the LED emits light, the light has a light form meeting the requirements for light form distribution regulated by ECE and SAE regulations.

The LED includes a support having a reflection accommodation area, a chip planted in the reflection accommodation area, and a molding compound covering the chip. The LED has a cross-axis symmetrical optical structure on a light emitting path, such that a light form of the light assumes a symmetrical cross-axis distribution due to the optical structure.

When the optical structure is a molding compound, the molding compound has a cross-axis symmetrical structure, and two ends of an axis are in the same shape, such as an arc shape, a triangular shape, or a square shape, such that when the light passes through the optical structure of the molding compound, the light form of the light assumes a cross-axis distribution.

Further, the optical structure of the present invention can also be the reflection accommodation area. When the optical structure is the reflection accommodation area, the reflection accommodation area has a cross-axis symmetrical structure, and two ends of an axis are in the same shape, such as an arc shape, a triangular shape, or a square shape, such that when the light passes through the optical structure of the reflection accommodation area, the light form of the light assumes a cross-axis distribution.

The structural improvement can achieve the purpose of the present invention. In order to make those skilled in the art understand the objects, features, and efficacy of the present invention, the present invention is illustrated in detail by the following embodiments with reference to the drawings.

### BREIF DESCRIPTION OF THE DRAWINGS

The present invention will become more fully understood from the detailed description given herein below for illustration only, and thus are not limitative of the present invention, and wherein:

FIG. 1 is a cross sectional view of a conventional LED;

FIG. 2 is light form distribution view of a conventional LED;

FIG. 3a is a luminous intensity distribution meeting the requirements of ECE regulations;

FIG. 3b is a light form distribution view of the luminous intensity of FIG. 3a;

FIG. 3c is a luminous intensity distribution meeting the requirements of SAE regulations;

FIG. 3d is a light form distribution view of the luminous intensity of FIG. 3c;

FIG. 4 is a three-dimensional view of a first embodiment of the present invention;

FIG. 5 is a light form distribution view of the first embodiment of the present invention;

FIG. 6 is a three-dimensional view of a second embodiment of the present invention;

FIG. 7 is a three-dimensional view of a third embodiment of the present invention;

FIG. 8a is a top view of an optical structure according to the first embodiment of the present invention;

FIG. 8b is a top view of an optical structure according to a forth embodiment of the present invention;

FIG. 8c is a top view of an optical structure according to a fifth embodiment of the present invention;

FIG. 8d is a top view of an optical structure according to a sixth embodiment of the present invention;

FIG. 9 is a three-dimensional view of the present invention applied to a Through-Hole LED; and

FIG. 10 is a three-dimensional view of the present invention applied to a Top LED.

### DESCRIPTION OF THE PREFERRED EMBODIMENT

The foregoing aspects, as well as many of the attendant advantages and features of this invention will become more apparent by reference to the following detailed description, when taken in conjunction with the accompanying drawings, wherein:

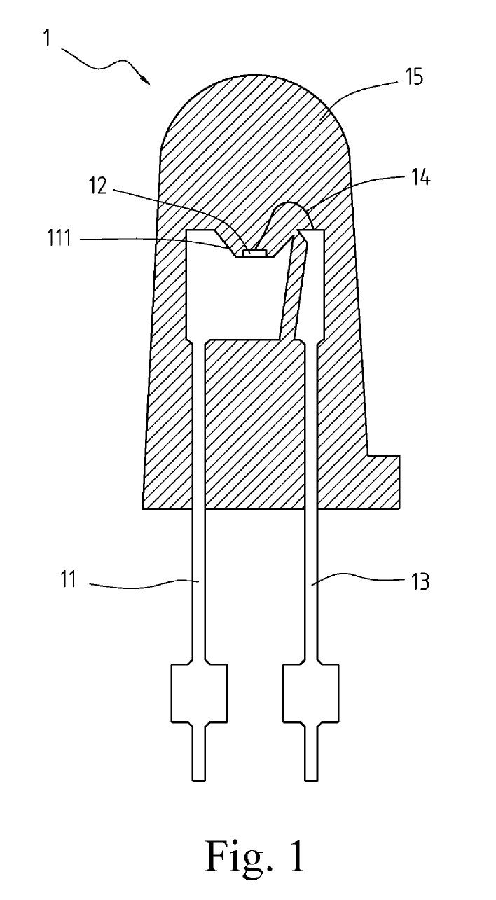

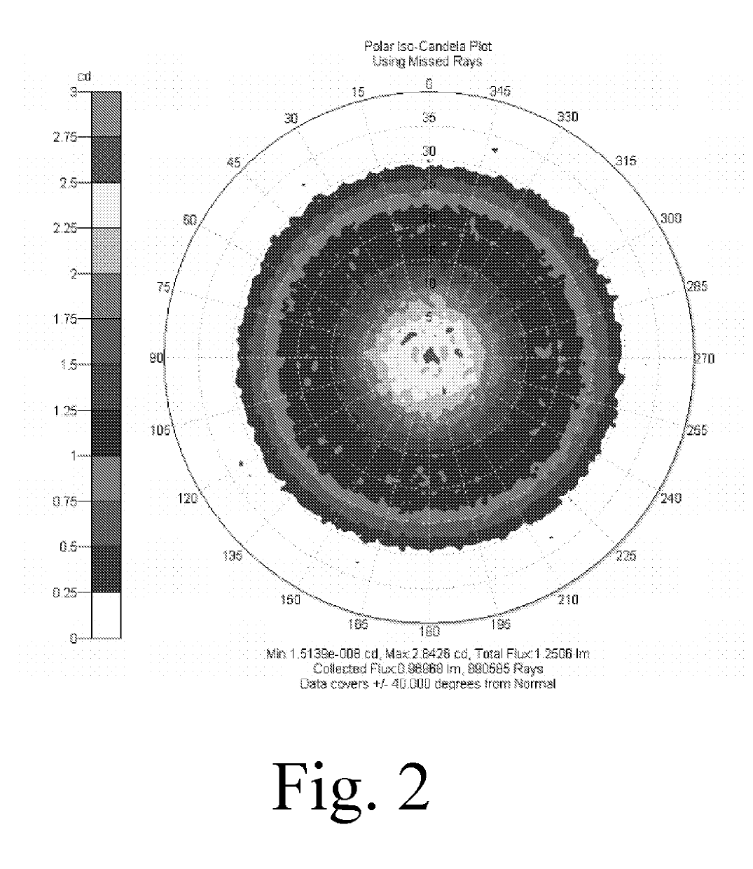

FIG. 1 is a cross sectional view of a conventional light emitting diode (LED). As shown in FIG. 1, a conventional LED 1 includes a support 11 having a reflection accommodation area 111, a chip 12 planted in the reflection accommodation area 111, another support 13 connected to the chip 12 through a gold thread 14, and a molding compound 15 with an end of a hemispherical column and covering the chip 12. Referring to FIG. 2, it is a light form view of the conventional LED. As the conventional LED 1 has a symmetrical optical structure, when the LED 1 emits light, the light form distribution of the light is as shown in FIG. 2 and assumes a symmetrical circular light form distribution.

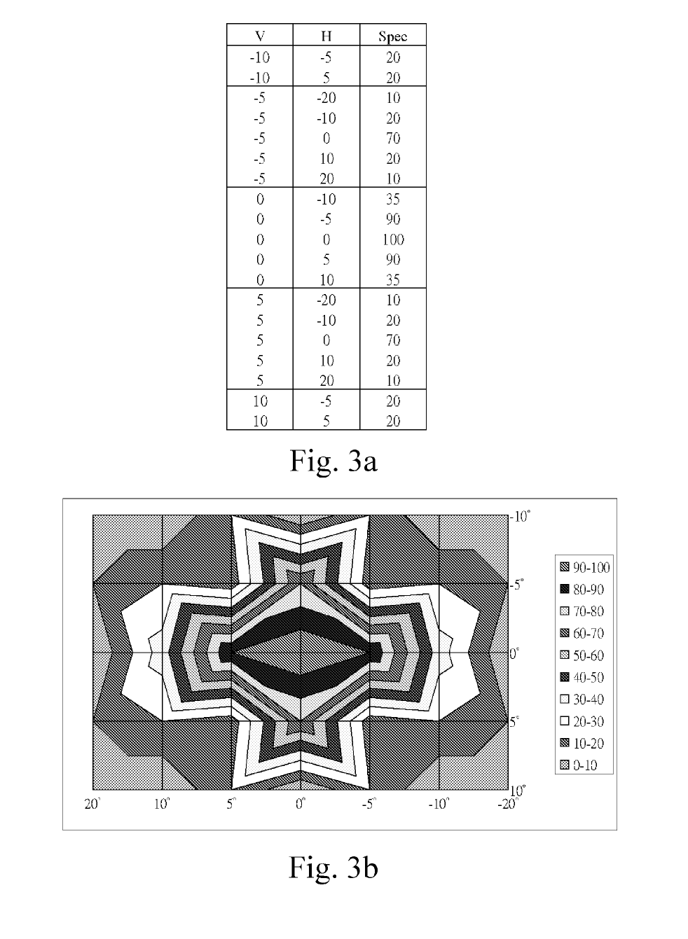

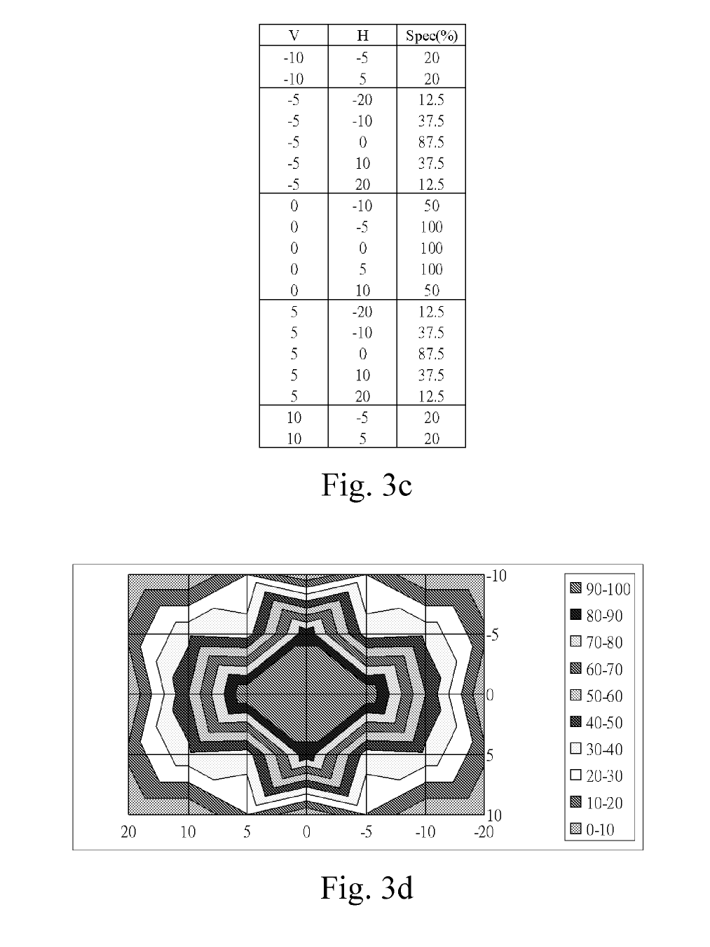

Next, referring to FIGS. 3a and 3b, FIG. 3a is a luminous intensity distribution regulated by ECE regulations, in which merely the luminous intensity regulated for the brake lights and indicators are illustrated, and FIG. 3b is a light form distribution view regulated by ECE regulations drawing with the luminous intensity of FIG. 3a corresponding to the angles of a longitudinal axis and a horizontal axis. Referring to FIGS. 3c and 3d, FIG. 3c is a luminous intensity regulated by SAE regulation, in which merely the luminous intensity regulated for the brake lights and indicators are illustrated, and FIG. 3d is a light form distribution view regulated by SAE regulations according to the luminous intensity of FIG. 3c corresponding to the angles of a longitudinal axis and a horizontal axis. It can be found by comparing the light form distribution views in FIGS. 3b and 3d that, the light form distributions defined by ECE and SAE all assume a symmetrical and cross-axis light form distribution. It can be found by further comparing with FIG. 2 that, the light form distribution of the conventional LED is different from those defined by ECE and SAE. When the conventional LED 1 is applied to an automotive lamp, in order to meet the requirements for the symmetrical and cross-axis light form distribution regulated by ECE or SAE, an additional shield is required or the number of the LEDs 1 is increased, which not only increases the cost, but also wastes the light energy and increases the power consumption.

Accordingly, the present invention provides an LED. The light form of the light emitted from the LED meets the requirements for the light form distribution regulated by ECE and SAE. The LED has a cross-axis symmetrical optical structure disposed on a light emitting path. Two ends of an axis of the optical structure are in the same shape, such that the light form distribution of the light can be in a symmetrical cross-axis distribution due to the optical structure.

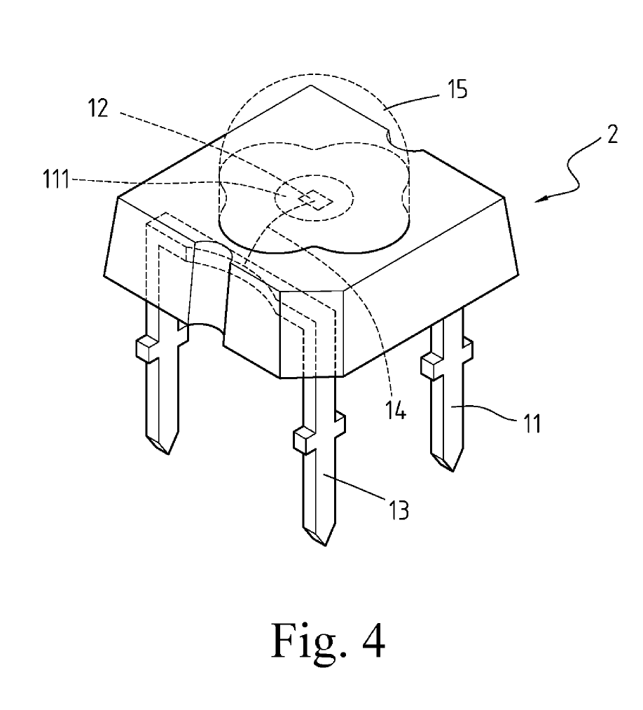

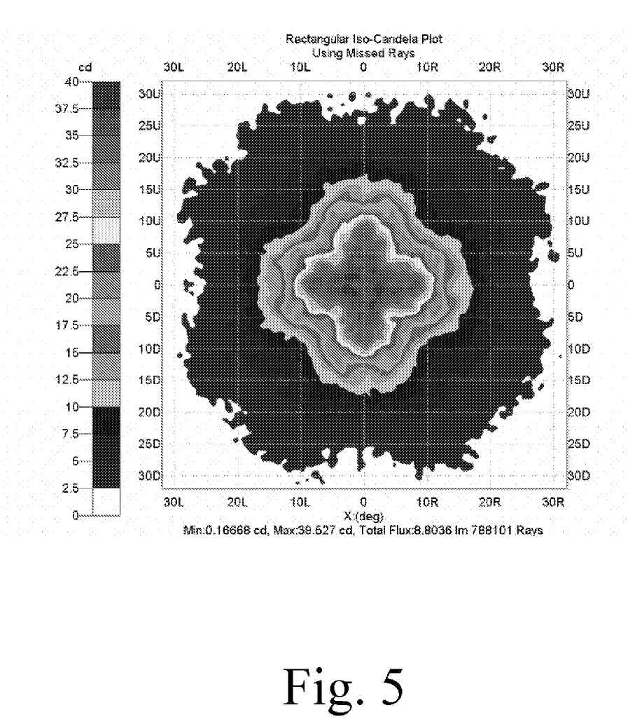

FIG. 4 is a three-dimensional view of a first embodiment of the present invention. As shown in FIG. 4, an LED 2 of this embodiment includes a support 11 having a reflection accommodation area 111, a chip 12 planted in the reflection accommodation area 111, and another support 13 connected to the chip 12 through a gold thread 14. The molding compound 15 has a cross-axis symmetrical optical structure. If the LED 2 is used to perform optical simulation, the simulation results shown in FIG. 5 can be obtained. FIG. 5 is a light form distribution view of the first embodiment. It can be known from FIG. 5 that the light form of the light emitted from the LED 2 assumes a symmetrical cross-axis light form distribution.

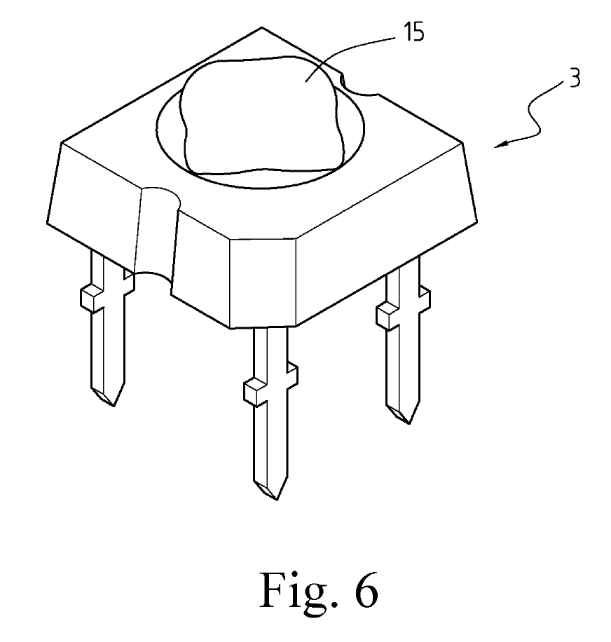

FIG. 6 is a three-dimensional view of a second embodiment of the present invention. The difference between this embodiment and the first embodiment lies in the optical structure of the molding compound 15. In the first embodiment, the molding compound 15 of the LED 3 is a cross-axis symmetrical optical structure (referring to FIG. 4). In the LED of this embodiment, the molding compound 15 further has a cross-axis symmetrical optical structure thereon, and the light emitted from the LED 3 also assumes a symmetrical cross-axis light form distribution due to the optical structure.

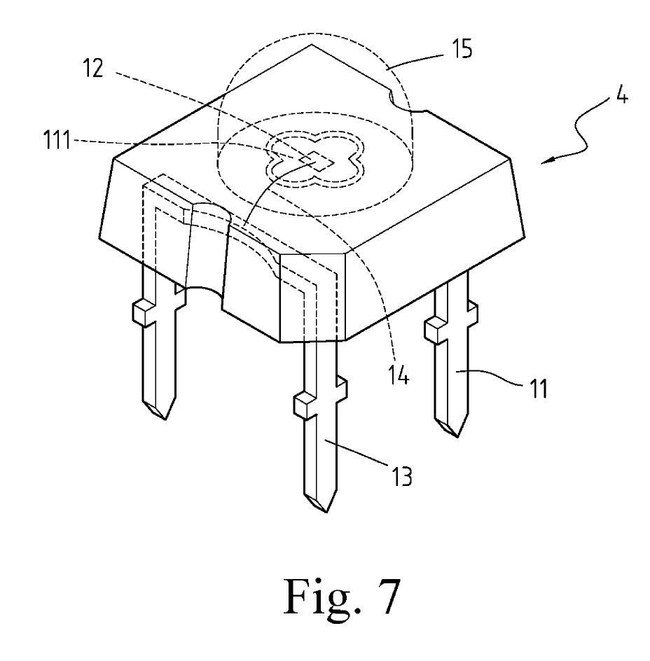

Further, according to the present invention, the same light form distribution can be obtained by an LED 4 shown in FIG. 7. FIG. 7 is a three-dimensional view of a third embodiment of the present invention. The LED 4 of this embodiment is characterized in that the reflection accommodation area 111 is a cross-axis symmetrical optical structure. When the LED 4 emits light, the light is reflected by the reflection accommodation area 111, such that the light form of the light assumes a symmetrical cross-axis light form distribution.

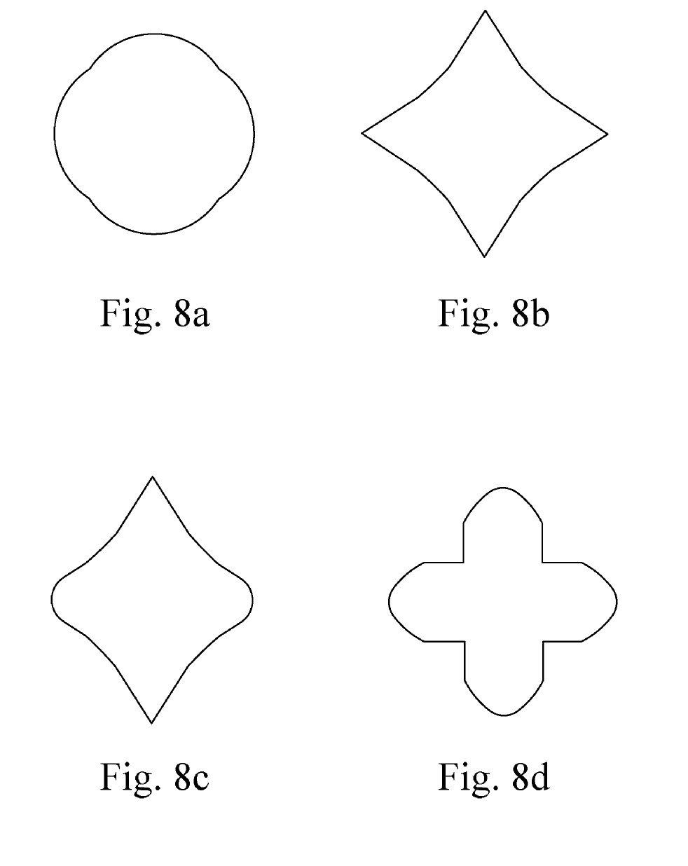

In the LED, the optical structure is a cross-axis symmetrical structure, and two ends of an axis must be in the same shape, such as an arc shape, a triangular shape, or a square shape, and the shape of the optical structure can make reference to FIGS. 8a, 8b, 8c, and 8d. FIG. 8a is an optical structural view of the first embodiment of the present invention, FIG. 8b is an optical structural view of a fourth embodiment of the present invention, FIG. 8c is an optical structural view of a fifth embodiment of the present invention, and FIG. 8d is an optical structural view of a sixth embodiment of the present invention.

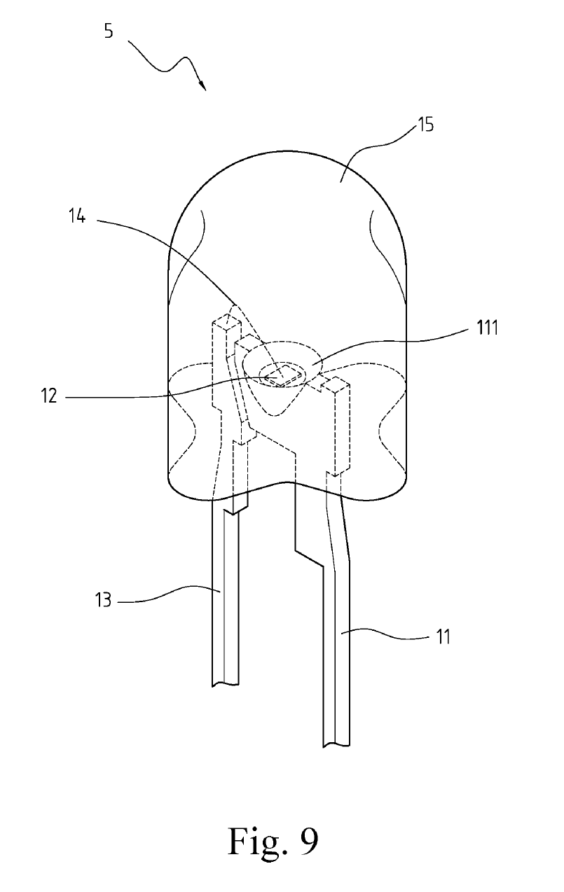

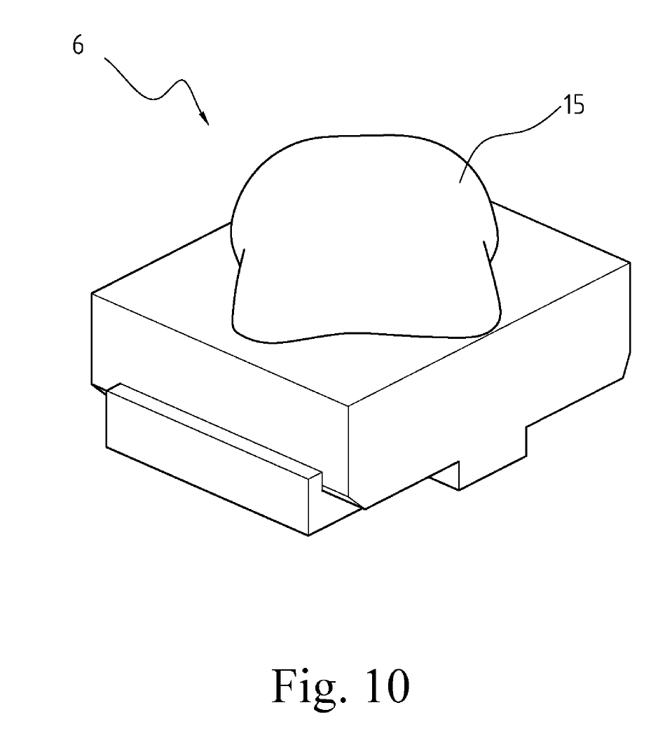

Further, the present invention is not merely as shown in FIGS. 4, 6, and 7, and the optical structure of the present invention is applicable in an Superflux LED, or as shown in FIGS. 9 and 10, applicable in a Through-Hole LED and a Top LED. FIG. 9 is a three-dimensional view of the present invention applied to a Through-Hole LED. A molding compound 15 of a LED 5 is a cross-axis symmetrical optical structure. When the LED 5 emits light, the light passes through the molding compound 15, such that the light form of the light assumes a cross-axis distribution. FIG. 10 is a three-dimensional view of the present invention applied to a Top LED. A molding compound 15 of a LED 6 is also a cross-axis symmetrical optical structure. As described above, when the LED 6 emits light, the light passes through the molding compound 15, such that the light form of the light assumes a cross-axis distribution.

While the present invention has been described in connection with a preferred embodiment thereof, it will be apparent to those skilled in the art that many changes and modifications may be made without departing from the true spirit and scope of the present invention. Accordingly, it is intended by the appended claims to cover all such changes and modifications as come within the spirit and scope of the invention.

What is claimed is:

1. A light emitting diode (LED) for an automotive lamp, comprising:
a support, having a reflection accommodation area;
a chip, planted in the reflection accommodation area; and
a molding compound, covering the chip,
wherein the LED has a cross-axis symmetrical optical structure on a light emitting path.

2. The LED for an automotive lamp as claimed in claim 1, wherein the molding compound is a cross-axis symmetrical optical structure, when the LED emits light, the light passes through the optical structure of the molding compound, such that a light form of the light assumes a cross-axis distribution.

3. The LED for an automotive lamp as claimed in claim 1, wherein the reflection accommodation area is a cross-axis symmetrical optical structure, when the LED emits light, the light form of the light assumes a cross-axis distribution due to the optical structure of the reflection accommodation area.

4. The LED for an automotive lamp as claimed in 1, wherein the LED is a Through-Hole LED, a SuperFlux LED, or Top LED.

5. The LED for an automotive lamp as claimed in claim 2, wherein two ends of an axis of the optical structure are in the same shape.

6. The LED for an automotive lamp as claimed in claim 5, wherein the two ends of the axis optical structure are in an arc shape, a triangular shape, or a square shape.

7. A light emitting diode (LED) for an automotive lamp, comprising:
a support, having a reflection accommodation area;
a chip, planted in the reflection accommodation area; and
a molding compound, covering the chip,
wherein the molding compound has a cross-axis symmetrical optical structure, when the LED emits light, the light passes through the optical structure of the molding compound, such that a light form of he light assumes a cross-axis distribution.

8. The LED for an automotive lamp as claimed in claim 7, wherein the LED is a Through-Hole LED, a SuperFlux LED, or a Top LED.

9. The LED for an automotive lamp as claimed in claim 7, wherein two ends of an axis of the optical structure are in the same shape.

10. The LED for an automotive lamp as claimed in claim 9, wherein the two ends of the axis of the optical structure are in an arc shape, a triangular shape, or a square shape.

11. A light emitting diode (LED) for automotive lamp, comprising:
a support, having a reflection accommodation area;
a chip, planted in the reflection accommodation area; and
a molding compound, covering the chip,
wherein the reflection accommodation area has a cross-axis symmetrical optical structure, when the LED emits light, a light form of the light assumes a cross-axis distribution due to the optical structure of the reflection accommodation area.

12. The LED for an automotive lamp as claimed in claim 11, wherein the LED is a Through-Hole LED, a SuperFlux LED, or a Top LED.

13. The LED for an automotive lamp as claimed in claim 11, wherein two ends of an axis of the optical structure are in the same shape.

14. The LED for an automotive lamp as claimed in claim 13, wherein the two ends of the axis of the optical structure are in an arc shape, a triangular shape, or a square shape.
